(19) United States
(12) Patent Application Publication
(10) Pub. No.: US 2011/0031356 A1
(43) Pub. Date: Feb. 10, 2011

(54) FASTENER

(76) Inventor: Lowell L. Vonada, Lincoln, KS (US)

Correspondence Address: Hovey Williams LLP, 10801 Mastin Blvd., Suite 1000, Overland Park, KS, 66210, US

(21) Appl. No.: 12/846,490

(22) Filed: Jul. 29, 2010

Related U.S. Application Data
(60) Provisional application No. 61/231,874, filed on Aug. 6, 2009.

(51) Int. Cl. F16L 3/08; F16M 13/02

(52) U.S. Cl. 248/71; 248/309.1

(57) ABSTRACT

A fastener is provided for attaching elongated members such as wire, conduit, tubing and the like to a supporting surface such as a post. The fastener includes a body having a bottom or engagement surface, the body including a head with a greater length and a toe with a relatively small length, and a neck on the body connecting the head and the toe. A holding area, which may be arcuate in configuration, is positioned between the head and the toe, is much smaller than the length of the head and positioned and configured to receive the elongated member. A hole, which may be a single hole, may extend through the height of the body and receive therethrough an attachment member such as a screw, for holding the fastener with the heel and toe against the supporting surface and retaining the elongated member in the holding area between the toe and the head.

### BACKGROUND OF THE INVENTION

1. Field of the Invention

The present invention relates to a fastener and a system useful for holding elongated members such as wire, cable, pipe and conduit to a supporting surface. More particularly, it is directed to providing a rugged yet economical fastener which has an enlarged head, a toe and a hole through which an attachment member is received.

2. Description of the Prior Art

In years past cattle fence wire was wire tied or stapled to wood fence post. The wire would work loose causing it to slip up or down on the post, and no longer will the wires be spaced properly. When staples were used they were hard to drive in hard woods such as hedge or locust and would work loose letting the wire fall off of the post. Livestock pushing on the back side of the fence would push the staples out of the post. Staples could only be used when livestock were held on the front side of the post.

Some fasteners are currently used for holding wires and the like. These include a metal half clamp, and staples such as those produced by the Gardner Bender company. While these are of useful items of hardware, in my experience they are unsuitable for applications where wire may encounter significant force, with the result that these fasteners may bend or will not hold against a fencepost or the like. When significant force is applied, these staples and other prior art fasteners will not hold fast to the post, and as force is applied, a portion raises free from the post, bending the staple, or the nail which holds it, and loosening the wire.

There is thus a need for a simple, economical fastener which uses a different configuration to overcome the problems with prior art devices.

### SUMMARY OF THE INVENTION

The present invention, provides an elegant solution to the problem of fasteners which avoids many of the problems associated with existing methods of fastening wire and other elongated members. In particular reference to a demanding field of application concerning livestock fences, the present invention is designed and configured to prevent or at least inhibit the movement of wire up and down on a fence post and will last many years.

In greater detail, the fastener of the present invention is designed such that when mounted by a screw, will hold to the wooden fencepost even with significant of livestock pressure from back or front sides. Advantageously, the present invention includes a body having relatively large head portion through which a hole extends, an adjacent holding area configured to receive therein the elongated member, and a toe. The fastener hereof is designed to hold wires, cables, pipes, and conduits firmly and quickly. This fastener is constructed with a thick, tall, strong body that applies pressure to the holding area of the base. An attachment member, most preferably a screw, is located in a hole near the toe side of the body to apply down pressure on the holding area of the base to both the head and the toe portions. By passing the screw through the hole and mounting it to the fencepost or other supporting surface, the present invention can resist substantial loads which would loosen other fasteners. With the invention of the portable battery electric drill, screws could now be used in remote areas allowing the fastener hereof to be mounted and used virtually anywhere.

While the attachment member used to mount the fastener to the fencepost or other support may be a nail, screws are the preferable attachment member for the following reasons:
Screws will hold better and not pull out which will allow livestock pressure from both sides of the fence. With nails livestock pressure from the back side of the post would push the nail out easily.
It is very hard to drive nails in the hard posts (e.g. locust, hedge) needed for long life posts. The nails will bend easy.
Today's screws go in easily and deep in hard woods.
If the fastener is located in a wrong position or if the fence builder/repairer decides to move the wire, they can easily back out the screw and place in a different location.

Moreover, due to the configuration of the fastener, only one attachment member, e.g. one screw, is required to successfully mount the fastener to the support, thereby saving material and labor.

While typically one fastener may be used to hold one elongated item such as wire, cable, conduit or pipe, if the item is relatively small in diameter in relation to the size of the holding area, more than one such item could be held by the same fastener. The fastener invention will last a very long time and furnishes a simple and inexpensive way of hanging wires, cables, pipes, and conduits. The fastener of the present invention can be used on woven wire and all types of wire, cables, conduits and pipes, and can be made in different sizes. The fastener disclosed herein is not limited to any specific dimensions. One advantage when used with, for example, coaxial cable, is that with a properly sized fastener, it is not possible to over pressure the cable—that is to pinch or crush it as it passes through the holding area.

The fastener can be made out of a variety of different types of material depending on the purpose. For example, the fastener of the present invention can be made out of metals, synthetic resins (commonly known as plastics) such as polyethylene or Bakelite, natural or synthetic rubber such as neoprene, or any other sturdy and substantially rigid material. Metal, such as aluminum, will work the best for fences. Insulating materials may be required in other situations.

These and other advantages will be readily apparent to those skilled in the art, with reference to the following description but limited only by the claims.

### BRIEF DESCRIPTION OF THE DRAWINGS

FIG. 1 is a perspective view of the fastener of the present invention with unseen edges shown in broken lines;

FIG. 2 is a perspective view of the fastener of FIG. 1, but showing a screw installed into the hole in the body of the fastener;

FIG. 3 is a perspective view of the fastener similar to FIG. 2, but showing a wire held within the holding area of the fastener; and

FIG. 4 is a perspective view similar to FIG. 3, showing the use of the fastener hereof to attach and hold several strands of barbed wire to a fencepost;

FIG. 5 is a perspective view similar to FIG. 1, where the fastener is provided with an enlarged wire-receiving opening; and

FIG. 6 is a side elevational view of the fastener shown in FIG. 5.

### DETAILED DESCRIPTION OF THE DRAWINGS

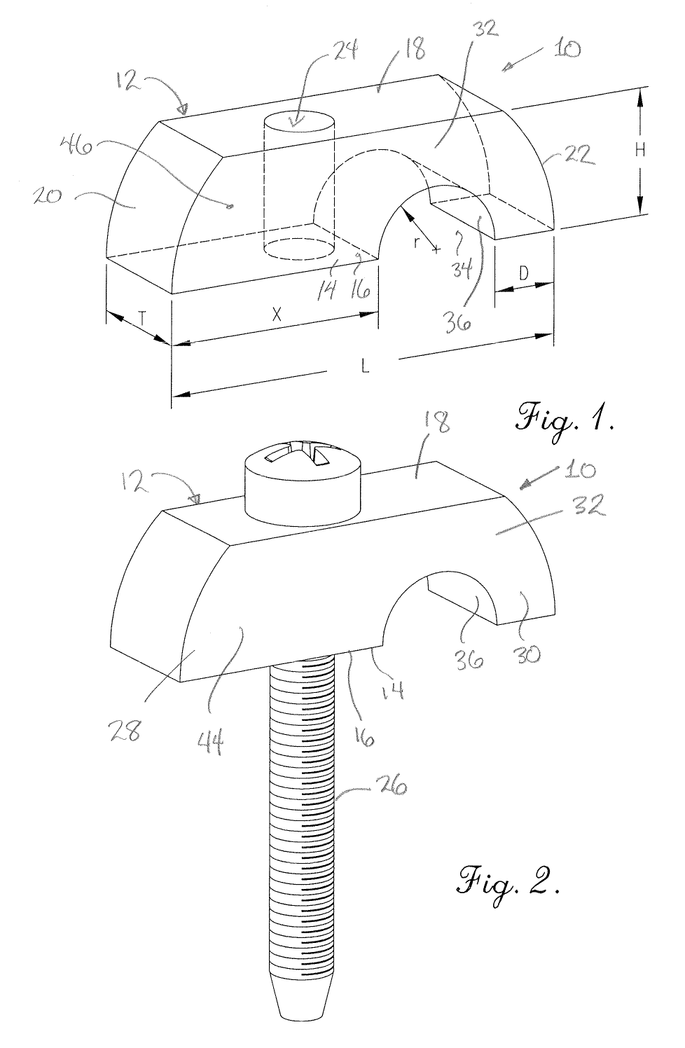

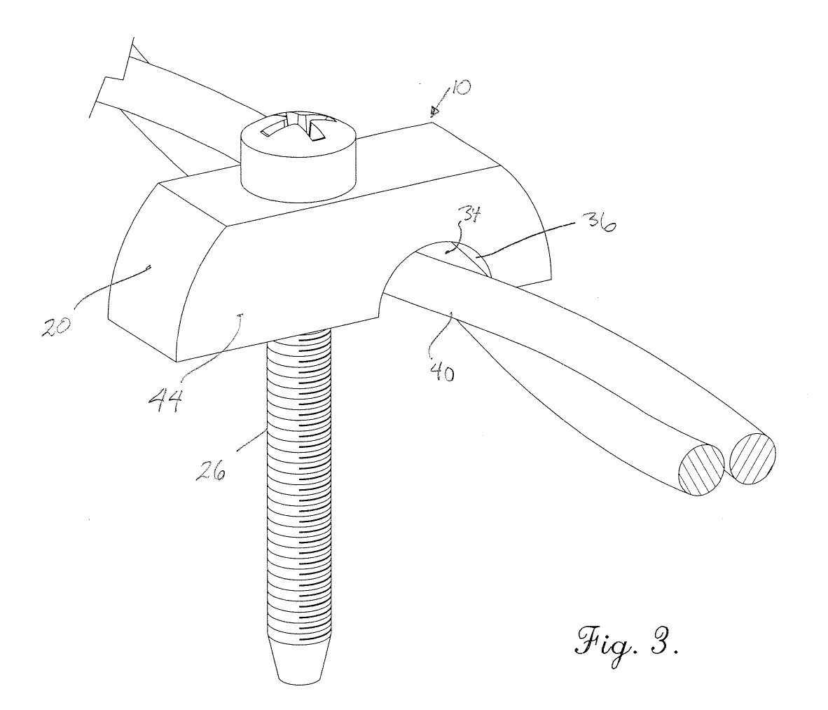

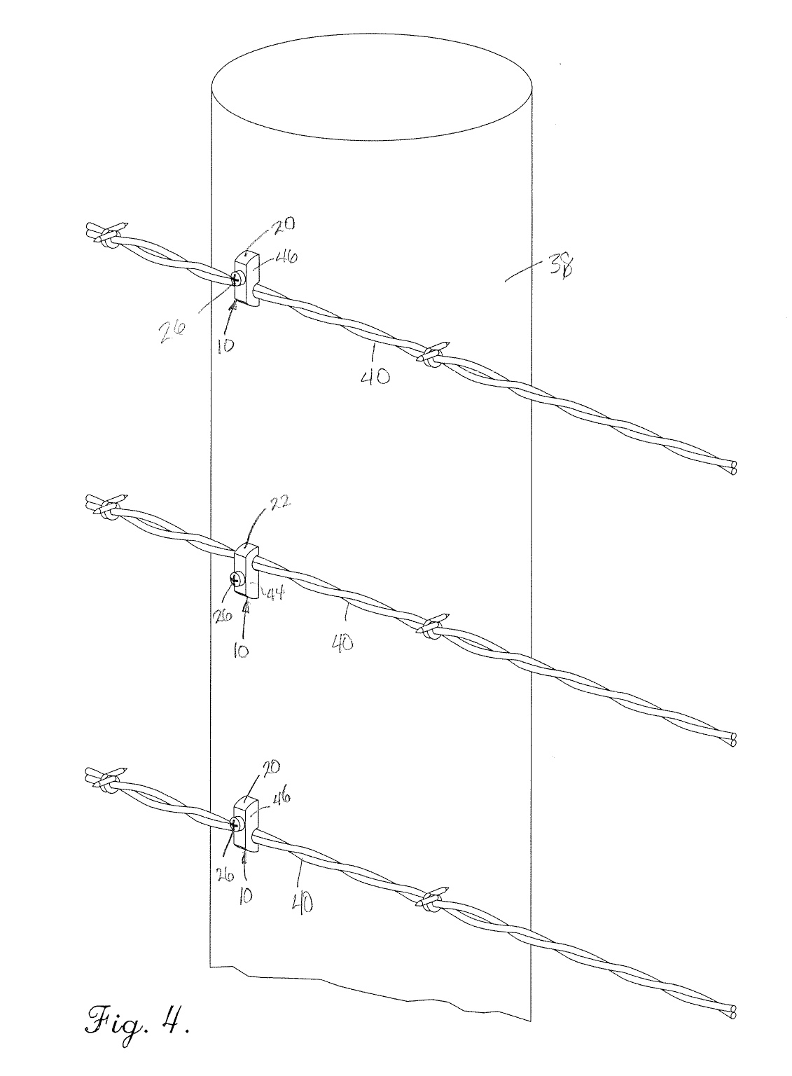

Referring now to the drawings, a fastener 10 in accordance with the present invention includes a body 12 having a base 14 including a bottom surface 16, a top surface 18 opposite to and spaced from the bottom surface 16, normally lower surface 20 and an opposite normally upper surface 22. The body 12 has a length L which, as shown in FIG. 4, is greater than its thickness T or its height H. A hole 24 extends through the body 12 from the top surface to the bottom surface and as shown in FIG. 1, is preferably smooth sided rather than threaded in order to permit ease of insertion and driving of a elongated attachment member having a shank and a head such as a nail or, more preferably, a threaded member such as a screw 26, as shown in FIGS. 2, 3 and 4. While a Phillips head screw is shown, it is to be understood that Torx screws, slotted screws, Allen head screws or other configurations of screw heads can be used.

The body 12 is most preferably stamped of aluminum or aluminum alloy, although it is to be understood that the body 12 may be forged, cast, machined or molded or otherwise fabricated of other materials as desired.

The fastener 10 is often oriented with the lower surface 20 positioned below the upper surface 22 as shown in FIG. 4, but of course can be oriented as desired by the application, the use of “top”, “bottom”, “upper” and “lower” being for ease of reference in regard to the drawing and description only, and not intended to be limiting in regard to the orientation of the fastener 10 during use. The lower surface 20 and the upper surface 22 are preferably arcuate and smooth to avoid snagging loose fabric or equipment or injuring livestock.

The base 14 includes a head 28 portion through which the hole 24 extends and a toe 30 portion, with a narrowed neck 32 portion located therebetween, the neck including an arcuate holding surface 36 defining, at least in part, a holding area 34 into which wire, conduit or the like is received. The length X of the head 28 measured along the bottom surface 16 is preferably greater than twice the length D of the toe portion 30 measured along the bottom surface 16. The holding surface 36 of the neck 32 may be, at least in part, arcuate in configuration. Also, the height H of the neck 32 (measured in the direction between the bottom surface 16 and the top surface 18) may be about the same as the length of the neck 32 (measured between the head 28 and the toe 30). For example, when the holding area 34 is semicircular as shown for the fastener 10 illustrated in FIG. 1, the height of the body and thus the top surface in the area of the neck is shown as H, the height between the bottom surface 16 and the top of the holding surface 36 is r, the height H may be about 2r, and the length of the holding area 34 and thus the neck 32 may be about 2r. The thickness of the neck at its narrowest portion is thus about r. The thickness of the body is T, which is greater than the length of the toe D, but less than the length of the head portion X.

By way of illustration for a fastener 10 which might be used to attach barbed wire to a support such as a post, the fastener 10 might have an overall length L of 26 mm, and the thickness T may be 8 mm. The height H may be 8 mm, and the dimension r may be about 4 mm. The length X of the head along the lower surface 20 may be about 14 mm, and the length D of the toe portion 30 may be about 4 mm. The length of the upper surface 22 may be about 19 mm. The diameter of the hole 24 may be about 4 mm, and the spacing between the most proximate portion of the hole 24 and the edge of the holding surface 36 may be about 1 mm. The hole 24 is thus positioned much closer to the holding area 34 than either the lower surface 20 or the upper surface 22. The length the shank portion of the screw 26 extending below the lower surface 20 may vary according to the supporting structure and intended use, but for example may be about 22 mm for a screw 26 useful with a steel or aluminum fastener having the dimensions as described herein.

The fastener body 12 further includes a pair of sidewalls 44 and 46. The sidewalls 44 and 46 may be substantially smooth and flat. The bottom surface 16 and the top surface 18 may be angled, or more preferably arcuate. This provides an advantage to the installer such as a ranch hand, by making the fastener 10 easier to handle. The height H of the fastener 10 is less than the length L or, for that matter, the length X of the head portion. This helps hold the toe portion against a supporting surface and resists raising of the bottom surface off of a support, such as a fence post, and also helps resist bending of an attachment member such as a nail or screw received in the hole.

As shown in FIGS. 3 and 4, the fastener 10 may be installed by screwing to a support such as a fence post 38, even if the fence post is a relatively hard wood such as hedge or locust. The fastener 10 may be installed most preferably by positioning the head 28 below the toe 30, with an elongated member such as a wire 40, or alternatively a cable, conduit or the like into the holding area 34 as illustrated in FIGS. 3 and 4. Then, the user inserts a screw 26 through the hole 24. For convenience, an electric drill having a suitable screwdriver bit is then used to drive the screw 26 into the support to hold the fastener 10 with its bottom surface 16 fast against the fence post 38 and with the wire 40 in the holding area 34 as shown in FIGS. 3 and 4. The screwhead 42 applies force to both the head 28 and the toe 30 to substantially prevent detachment of the wire 38 from the fastener 10 and the threads of the screw 26 substantially prevent the loosening or dislodgement of the fastener 10 from the fence post 38 or other support.

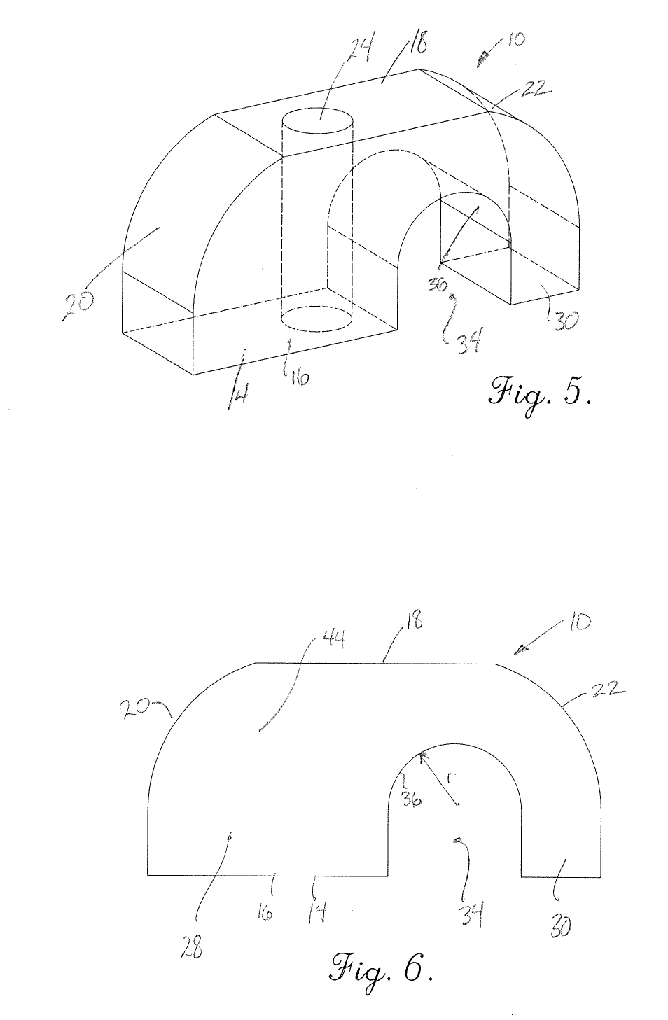

As shown in FIGS. 5 and 6, the holding area of the fastener 10 can be configured to hold elongated members which have a greater cross-sectional area than the two-strand barbed wire shown in FIGS. 3 and 4. For example, co-axial cable or the like with a more circular configuration may be held by a fastener with a holding area 34 having a greater height as shown in FIGS. 5 and 6. As shown, the top part of the holding surface 36 remains arcuate and may have a radius r as shown in FIG. 1, but the overall height H is increased. Thus, the distance between the bottom surface 16 and the top of the holding surface 36 is about 2r, the height H is about 3r, and thus the thickness of the neck 32 at its narrowest is about r.

As a result, I have provided a fastener or fixture which is useful for holding wire such as barbed wire, cables, pipes, conduits such as coaxial cable, and other elongated members. The fastener body is able to hold these elongated members securely, and to withstand significant forces imparted by livestock such as cattle or bison which might loosen or weaken staples or other attachment devices. By having a body which locates the hole for receiving the attachment member and having a head with a large surface area, force imparted by livestock against the wire has a smaller moment arm on the attachment member. The large-sized head, being on the opposite side of the screw or other attachment member from the holding area, further resists imposition of a moment arm by presenting a substantial area of contact with the post or other supporting surface to which it is attached. The long head also assists in applying pressure to the holding area and the toe. The body of the fastener has substantial height and thickness to resist deformation, provide strength, and reinforce the shank of a screw or other attachment member in the manner of a collar. Of course, the size and dimensions may vary according to the particular application, and can be used to hold in place all manner of wires, conduits, tubes, cables and the like.

Although preferred forms of the invention have been described above, it is to be recognized that such disclosure is by way of illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of his invention as pertains to any apparatus not materially departing from but outside the literal scope of the invention as set out in the following claims.

1. A fastener for holding an elongated member to a supporting surface, said fastener comprising an elongated body extending between a lower surface and an upper surface, said body having a bottom surface, said body including a head portion and a toe portion, said head portion being connected to said toe portion by a neck having a holding surface, at least a portion of said holding surface being arcuate said bottom surface being interrupted by a holding area between the head portion and the toe portion, said holding area being located adjacent said neck, said head portion including structure defining a hole extending through said head portion, said hole extending through said body substantially perpendicular to a plane extending along said bottom surface and being sized and configured to receive a fastener therethrough, said bottom surface extending along said head portion a length X and extending along said toe portion a length D, said body further including a top surface, the body having a height H, said holding area having a length 2r between said head portion and said toe portion, wherein length X is at least twice length D, length X is greater than length 2r, and length X is greater than height H.

2. A fastener as set forth in claim 1, wherein said hole is positioned in said head portion more proximate said holding area than either of said lower surface or said upper surface.

3. A fastener as set forth in claim 1, wherein said top surface is substantially planar and parallel to said bottom surface, and said lower surface and said upper surface are both at least partially arcuate in configuration.

4. A fastener as set forth in claim 1, wherein said body has a thickness T, said thickness T being about less than or equal to said height H and less than or equal to said length 2r of said holding area.

5. A fastener as set forth in claim 1, wherein said body has a pair of substantially flat sidewalls presenting therebetween a thickness T, the thickness T being greater than the length D.

6. A retaining system for elongated members comprising, in combination:
an elongated member selected from the group consisting of wires, conduit and cable, and combinations thereof;
a support member; and
a retainer for securing the elongated member to the elongated member to the support member, the retainer including:
a fastener comprising an elongated body extending between a lower surface and an upper surface, said body having a bottom surface, said body including a head portion and a toe portion, said head portion being connected to said toe portion by a neck having a holding surface, at least a portion of said holding surface being arcuate said bottom surface being interrupted by a holding area between the head portion and the toe portion, said holding area being located adjacent said neck, said head portion including structure defining a hole extending through said head portion, said hole extending through said body substantially perpendicular to a plane extending along said bottom surface and being sized and configured to receive a fastener therethrough, said bottom surface extending along said head portion a length X and extending along said toe portion a length D, said body further including a top surface, the body having a height H, said holding area having a length 2r between said head portion and said toe portion, wherein length X is at least twice length D, length X is greater than length 2r, and length X is greater than height H; and
an attachment member extending through said hole and received in said support member, said attachment member having a head in engagement with said top surface for holding said fastener to said support member with said elongated member held within said holding area.

7. A system as set forth in claim 6, wherein said attachment member is selected from the group consisting of nails and threaded fasteners.

8. A fastener as set forth in claim 6, wherein said hole is positioned in said head portion more proximate said holding area than either of said lower surface or said upper surface.

9. A fastener as set forth in claim 6, wherein said top surface is substantially planar and parallel to said bottom surface, and said lower surface and said upper surface are both at least partially arcuate in configuration.

10. A fastener as set forth in claim 6, wherein said body has a thickness T, said thickness T being about less than or equal to said height H and less than or equal to said length 2r of said holding area.

11. A system as set forth in claim 6, wherein the top surface adjacent said hole is substantially flat and parallel to the bottom surface adjacent said hole.

12. A system as set forth in claim 6, wherein said height H is greater than the length 2r of the holding area between the head portion and the toe portion.

13. A fastener as set forth in claim 6, there being only one hole extending between said top surface and said bottom surface.

14. A fastener as set forth in claim 6, wherein said body has a pair of substantially flat sidewalls presenting therebetween a thickness T, the thickness T being greater than the length D.
